(19) United States
(12) Patent Application Publication
(10) Pub. No.: US 2009/0084237 A1
(43) Pub. Date: Apr. 2, 2009

(54) Apparatus for retrieving recyclable metal from an electrical cable

(76) Inventor: Allan R. Adams, Stoughton, WI (US)

Correspondence Address: DAVID J. ARCHER, 7037 POMERY ROAD, ROCKTON, IL, 61072, US

(21) Appl. No.: 12/284,153

(22) Filed: Sep. 18, 2008

Related U.S. Application Data
(60) Provisional application No. 60/995,753, filed on Sep. 28, 2007.

(51) Int. Cl. B26D 7/06

(52) U.S. Cl. 83/426

(57) ABSTRACT

An apparatus is disclosed for retrieving recyclable metal from an electrical cable having a core strand and wound strands wound about the core strand. The apparatus includes a frame having a first and a second end and a first and a second side. A motor is mounted on the frame and a drive is drivably connected to the motor. A rotor is rotatably supported by the frame, the rotor being drivingly connected to the drive such that when the motor is energized, the motor rotates the rotor about an axis of rotation of the rotor. The rotor defines a channel for the passage therethrough of the core strand. The channel extends coaxially about the axis of rotation of the rotor. The rotor also defines a bore for the passage therethrough of the wound strands. The bore is disposed parallel to and spaced relative to the axis of rotation. The bore has an inlet and an outlet. A shear is secured to the frame adjacent to the rotor. The arrangement is such that when the rotor is rotating and the wound strands are urged through the bore, the outlet of the bore interacts with the shear for shearing a recyclable length of the wound strands for recycling thereof.

### CROSS REFERENCE TO RELATED APPLICATION

The present application is a Complete application filed pursuant to Provisional application U.S. Ser. No. 60/995,753 filed Sep. 28, 2007. All of the disclosure of U.S. Ser. No. 60/995,753 is incorporated herein by reference.

### BACKGROUND OF THE INVENTION

1. Field of the Invention

The present invention relates to an apparatus for retrieving recyclable metal from an electrical cable. More specifically, the present invention relates to an apparatus for retrieving recyclable metal from an electrical cable having a core strand and wound strands wound about the core strand.

2. Background Information

When a house, office or factory is rewired, enormous quantities of scrap electrical cable are generated. In the past, in an attempt to recover the valuable metal such as copper from the used cable, such scrap cable was burnt so as to remove the plastic insulation therefrom. However, with the advent and implementation of rigorous Environmental Protection Agency (EPA) and Department of Natural Resources regulations prohibiting burning of waste plastics on electrical cables, the recovery of such valuable metal has been challenging. Primarily, the EPA and Department of Natural Resources regulations introduced approximately 16 years ago were introduced in order to prevent the release into the atmosphere of harmful gases given off during burning of plastics materials such as wire insulation.

More specifically, the approximate value of stripped copper wire is 50 cents per lb. However, the value of unstripped copper wire is only approximately 16 cents per lb. The cable stripping apparatus according to U.S. Pat. No. 6,694,853 to Adams provides an extremely efficient means for rapidly removing insulation from electrical cables of various gauges.

However, many electrical cables when stripped of their outer casing include a core strand and wound strands wound about the core strand. More specifically, the core strand is often a steel strand and the wound strands which are wound about such steel core strand may be of copper or aluminum.

Applicant has discovered that the valuable copper or aluminum wound strands can be retrieved by uncoiling, at the lead end of the cable, the wound strands from the central steel core strand. Such copper or aluminum wound strands are then threaded through a bore of a rotor while the steel core strand is threaded through a central channel of the rotor. Thereafter, the steel core strand is manually or mechanically pulled through the channel while the rotor is rotated by means of a motor. A stationary shear interacts with a recyclable length of the copper or aluminum outer wound strands as such wound strands emerge from the bore. The arrangement is such that these recyclable lengths of copper or aluminum are sheared for recycling thereof.

Thus the primary feature of the present invention is to provide an apparatus for retrieving recyclable metal from an electrical cable having a core strand and wound strands wound about the core strand.

Another important feature of the present invention is to provide an apparatus for retrieving recyclable metal such as copper or aluminum from an electrical cable having a core strand and wound strands wound about the core strand so that the sheared lengths of copper or aluminum can be recycled.

Other features and advantages of the present invention will be readily apparent to those skilled in the art by a consideration of the detailed description of a preferred embodiment of the present invention contained herein.

### SUMMARY OF THE INVENTION

The present invention relates to an apparatus for retrieving recyclable metal from an electrical cable having a core strand and wound strands wound about the core strand. The apparatus includes a frame having a first and a second end and a first and a second side. A motor is mounted on the frame and a drive is drivably connected to the motor. A rotor is rotatably supported by the frame, the rotor being drivingly connected to the drive such that when the motor is energized, the motor rotates the rotor about an axis of rotation of the rotor. The rotor defines a channel for the passage therethrough of the core strand. The channel extends coaxially about the axis of rotation of the rotor. The rotor also defines a bore for the passage therethrough of the wound strands. The bore is disposed parallel to and spaced relative to the axis of rotation and has an inlet and an outlet. A shear is secured to the frame adjacent to the rotor. The arrangement is such that when the rotor is rotating and the wound strands are urged through the bore, the outlet of the bore interacts with the shear for shearing a recyclable length of the wound strands for recycling thereof.

In a more specific embodiment of the present invention, the frame includes a main frame having the first and a second end and the first and a second side.

Moreover, the frame includes a sub-frame which extends from the main frame.

More specifically, the sub-frame includes a first plate which extends between the first and second ends of the main frame.

A second plate is disposed spaced and parallel to the first plate such that the first and second plate rotatably support the rotor.

Also, the main frame is of rectangular configuration and the motor is an electric motor.

A switch is provided for selectively permitting forward and reverse rotation of the motor when energized.

Additionally, a reduction gearbox is drivingly connected to the motor, the gearbox having an input and an output. The input is driven by the motor and the output is drivingly connected to the drive.

Furthermore, the output of the gearbox includes a drive sprocket and the drive is a chain.

Also, the rotor includes a first and a second portion;

A driven sprocket is secured to the first portion of the rotor. The driven sprocket cooperates with the drive such that the driven sprocket is driven by the drive so that the driven sprocket and the first portion of the rotor are rotated about the axis of rotation.

The second portion of the rotor is secured to the first portion of the rotor. The second portion is disposed between the first and second plates of the sub-frame such that the first and second plates rotatably support the second portion.

Additionally, the second portion of the rotor has a first and a second extremity. and defines an outer surface of cylindrical configuration.

Furthermore, the cylindrical outer surface of the second portion extends from the first extremity of the second portion to the second extremity thereof.

Moreover, a plurality of bearings are supported by the first and second plates of the sub-frame. The bearings are disposed between the plates and are spaced circumferentially around the outer surface of the second portion of the rotor for bearingly supporting the second portion of the rotor.

The plurality of bearings includes a first bearing having a first rod which extends between the plates, the first rod being secured to the plates. The first bearing includes a first roller bearing. The first roller bearing includes a first cylindrical axle which defines a first axially extending passageway for the reception therein of the first rod. A first locking device is provided for locking the first cylindrical axle onto the first rod for preventing rotation and axial movement of the first cylindrical axle relative to the first rod. Additionally, a first sleeve is disposed coaxially relative to the first cylindrical axle and a first bearing race is disposed between the first sleeve and the first cylindrical axle. The first bearing also includes a second roller bearing. The second roller bearing includes a second cylindrical axle which defines a second axially extending passageway for the reception therein of the first rod. A second locking device is provided for locking the second cylindrical axle onto the first rod for preventing rotation and axial movement of the second cylindrical axle relative to the first rod. The second locking device is disposed adjacent to the first locking device. A second sleeve is disposed coaxially relative to the second cylindrical axle. Also, a second bearing race is disposed between the second sleeve and the second cylindrical axle.

Furthermore, a second bearing includes a second rod which extends between the plates, the second rod being secured to the plates. A third roller bearing includes a third cylindrical axle which defines a third axially extending passageway for the reception therein of the second rod. Also, a third locking device is provided for locking the third cylindrical axle onto the second rod for preventing rotation and axial movement of the third cylindrical axle relative to the second rod. A third sleeve is disposed coaxially relative to the third cylindrical axle and a third bearing race is disposed between the third sleeve and the third cylindrical axle. Additionally, a fourth roller bearing includes a fourth cylindrical axle which defines a fourth axially extending passageway for the reception therein of the second rod. A fourth locking device is provided for locking the fourth cylindrical axle onto the second rod for preventing rotation and axial movement of the fourth cylindrical axle relative to the second rod. The fourth locking device is disposed adjacent to the third locking device. A fourth sleeve is disposed coaxially relative to the fourth cylindrical axle. Also, a fourth bearing race is disposed between the fourth sleeve and the fourth cylindrical axle.

Additionally, the plurality of bearings includes a fifth bearing which has a third rod extending between the plates, the third rod being secured to the plates. A fifth roller bearing includes a fifth cylindrical axle which defines a fifth axially extending passageway for the reception therein of the third rod. A fifth locking device is provided for locking the fifth cylindrical axle onto the third rod for preventing rotation and axial movement of the fifth cylindrical axle relative to the third rod. A fifth sleeve is disposed coaxially relative to the fifth cylindrical axle and a fifth bearing race is disposed between the fifth sleeve and the fifth cylindrical axle. Also, a sixth roller bearing includes a sixth cylindrical axle which defines a sixth axially extending passageway for the reception therein of the third rod. A sixth locking device is provided for locking the sixth cylindrical axle onto the third rod for preventing rotation and axial movement of the sixth cylindrical axle relative to the third rod. The sixth locking device is disposed adjacent to the fifth locking device. A sixth sleeve is disposed coaxially relative to the sixth cylindrical axle. Also, a sixth bearing race is disposed between the sixth sleeve and the sixth cylindrical axle.

A fourth bearing includes a fourth rod which extends between the plates, the fourth rod being secured to the plates. A seventh roller bearing includes a seventh cylindrical axle which defines a seventh axially extending passageway for the reception therein of the fourth rod. A seventh locking device is provided for locking the seventh cylindrical axle onto the fourth rod for preventing rotation and axial movement of the seventh cylindrical axle relative to the fourth rod. A seventh sleeve is disposed coaxially relative to the seventh cylindrical axle. Also, a seventh bearing race is disposed between the seventh sleeve and the seventh cylindrical axle. Additionally, an eighth roller bearing includes an eighth cylindrical axle which defines an eighth axially extending passageway for the reception therein of the fourth rod. An eighth locking device is provided for locking the eighth cylindrical axle onto the fourth rod for preventing rotation and axial movement of the eighth cylindrical axle relative to the fourth rod. The eighth locking device is disposed adjacent to the seventh locking device. An eighth sleeve is disposed coaxially relative to the eighth cylindrical axle. Also, an eighth bearing race is disposed between the eighth sleeve and the eighth cylindrical axle.

Furthermore, an anchor is disposed between the plates and is located adjacent to the third and fourth bearings, the anchor being secured to at least one of the plates.

A first adjustment device threadably cooperates with the anchor and the first adjustment device selectively urges the third rod relative to the cylindrical outer surface of the second portion of the rotor, the third rod having a first and a second end.

Moreover, a second adjustment device threadably cooperates with the anchor and the second adjustment device selectively urges the fourth rod relative to the cylindrical outer surface of the second portion of the rotor, the fourth rod having a first and a second extremity.

The first plate defines a first slot for the adjustable reception therein of the first end of the third rod.

Also, the first plate defines a second slot for the adjustable reception therein of the first extremity of the fourth rod.

Additionally, the second plate defines a third slot for the adjustable reception therein of the second end of the third rod.

Furthermore, the second plate defines a fourth slot for the adjustable reception therein of the second extremity of the fourth rod. The arrangement is such that when the first and second adjustment devices are rotated relative to the anchor, a disposition of the fifth, sixth, seventh and eighth sleeves relative to the cylindrical outer surface of the second portion of the rotor is adjusted so that a smooth rotation of the rotor is attained.

The shear includes a blade having a first and a second termination and a first and a second edge. The first edge of the blade defines a first shearing surface and the second edge of the blade defines a second shearing surface.

An anchoring plate cooperates with the first termination of the blade and a plurality of fasteners are provided for securing the anchoring plate to the second plate of the sub-frame.

A threaded fastening device extends through the anchoring plate and cooperates with the blade adjacent to the first termination of the blade for securing the blade adjacent to the outlet of the bore.

Also, a collar threadably cooperates with the channel of the rotor for locating the second termination of the blade so that the blade shears through the recyclable length of the wound strands when the rotor rotates relative to the blade.

Many modifications and variations of the present invention will be readily apparent to those skilled in the art by a consideration of the detailed description with particular reference to the annexed drawings that show a preferred embodiment of the present invention. However, such modifications and variations fall within the spirit and scope of the present invention as defined by the appended claims.

### BRIEF DESCRIPTION OF THE DRAWINGS

FIG. 1 is a top plan view of an apparatus for retrieving recyclable metal from an electrical cable having a core strand and wound strands wound about the core strand;

FIG. 2 is a view taken on the line 2-2 of FIG. 1;

FIG. 3 is an enlarged view of the rotor shown in FIG. 1;

FIG. 4 is a sectional view taken on the line 4-4 of FIG. 2;

FIG. 5 is a similar view to that shown in FIG. 2 but is shown partly in section; and

FIG. 6 is a view taken on the line 6-6 of FIG. 1.

Similar reference characters refer to similar parts throughout the various views of the drawings.

### DETAILED DESCRIPTION OF THE DRAWINGS

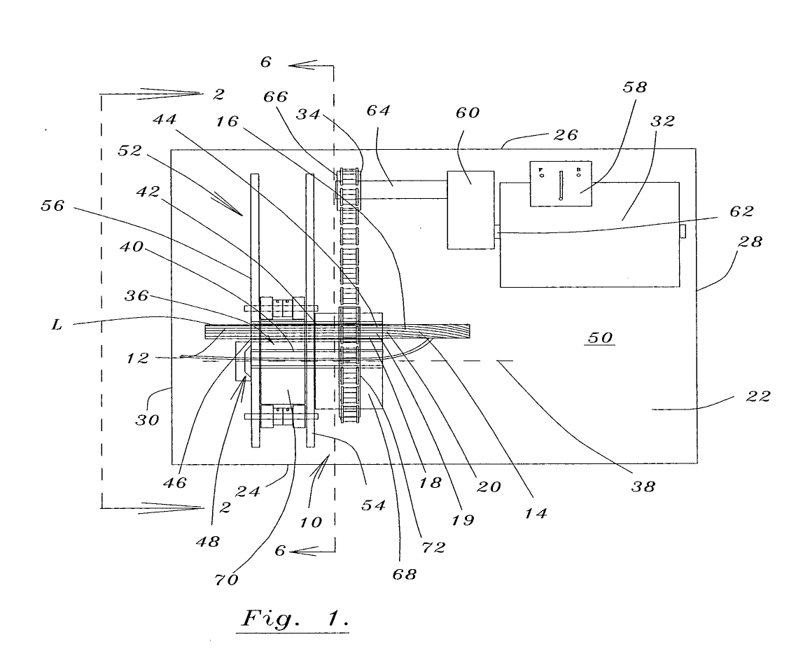

FIG. 1 is a top plan view of an apparatus generally designated 10 according to the present invention for retrieving recyclable metal 12 from an electrical cable 14 having a core strand 16 and wound strands 18, 19 and 20 wound about the core strand 16.

As shown in FIG. 1, the apparatus 10 includes a frame 22 having a first end 24 and a second end 26 and a first side 28 and a second side 30. A motor 32 is mounted on the frame 22 and a drive 34 is drivably connected to the motor 32. A rotor generally designated 36 is rotatably supported by the frame 22, the rotor 36 being drivingly connected to the drive 34 such that when the motor 32 is energized, the motor 32 rotates the rotor 36 about an axis of rotation 38 of the rotor 36. The rotor 36 defines a channel 40 for the passage therethrough of the core strand 16. The channel 40 extends coaxially about the axis of rotation 38 of the rotor 36. The rotor 36 also defines a bore 42 for the passage therethrough of the wound strands 18 to 20. The bore 42 is disposed parallel to and spaced relative to the axis of rotation 38. The bore 42 has an inlet 44 and an outlet 46. A shear generally designated 48 is secured to the frame 22 adjacent to the rotor 36. The arrangement is such that when the rotor 36 is rotating and the wound strands 18-20 are urged through the bore 42, the outlet 46 of the bore 42 interacts with the shear 48 for shearing a recyclable length L of the wound strands 18-20 for recycling thereof.

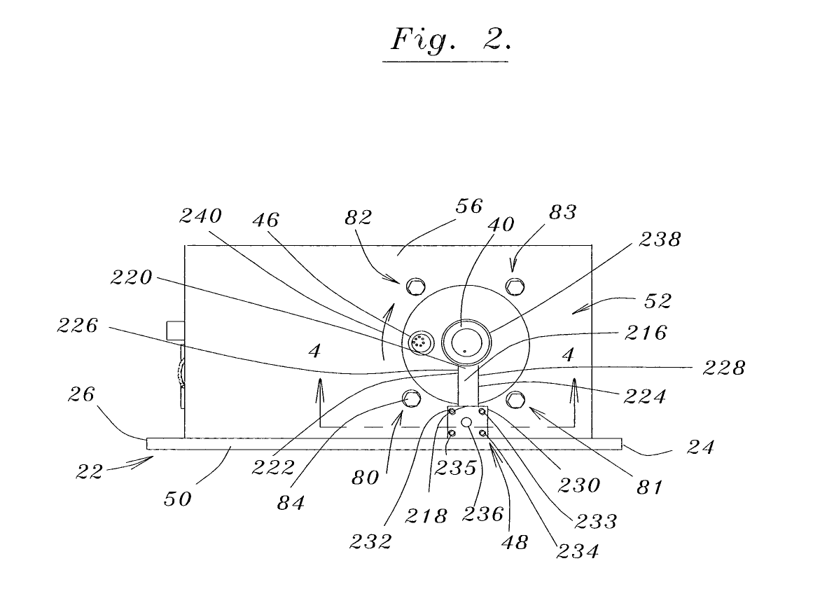

FIG. 2 is a view taken on the line 2-2 of FIG. 1. As shown in FIG. 2, the frame 22 includes a main frame 50 having the first end 24 and the second end 26.

Moreover, the frame 22 includes a sub-frame generally designated 52 which extends from the main frame 50.

As shown in FIG. 1, the sub-frame 52 includes a first plate 54 which extends between the first end 24 and the second end 26 of the main frame 50.

A second plate 56 is disposed spaced and parallel to the first plate 54 such that the first plate 54 and the second plate 56 rotatably support the rotor 36.

Also, the main frame 50 is of rectangular configuration and the motor 32 is an electric motor.

A switch 58 is provided for selectively permitting forward rotation F and reverse rotation R of the motor 32 when energized.

Additionally, a reduction gearbox 60 is drivingly connected to the motor 32, the gearbox 60 having an input 62 and an output 64. The input 62 is driven by the motor 32 and the output 64 is drivingly connected to the drive 34.

Furthermore, the output 64 of the gearbox 60 includes a drive sprocket 66 and the drive 34 is a chain.

Also, the rotor 36 includes a first portion 68 and a second portion 70.

A driven sprocket 72 is secured to the first portion 68 of the rotor 36. The driven sprocket 72 cooperates with the drive 34 such that the driven sprocket 72 is driven by the drive 34 so that the driven sprocket 72 and the first portion 68 of the rotor 36 are rotated about the axis of rotation 38.

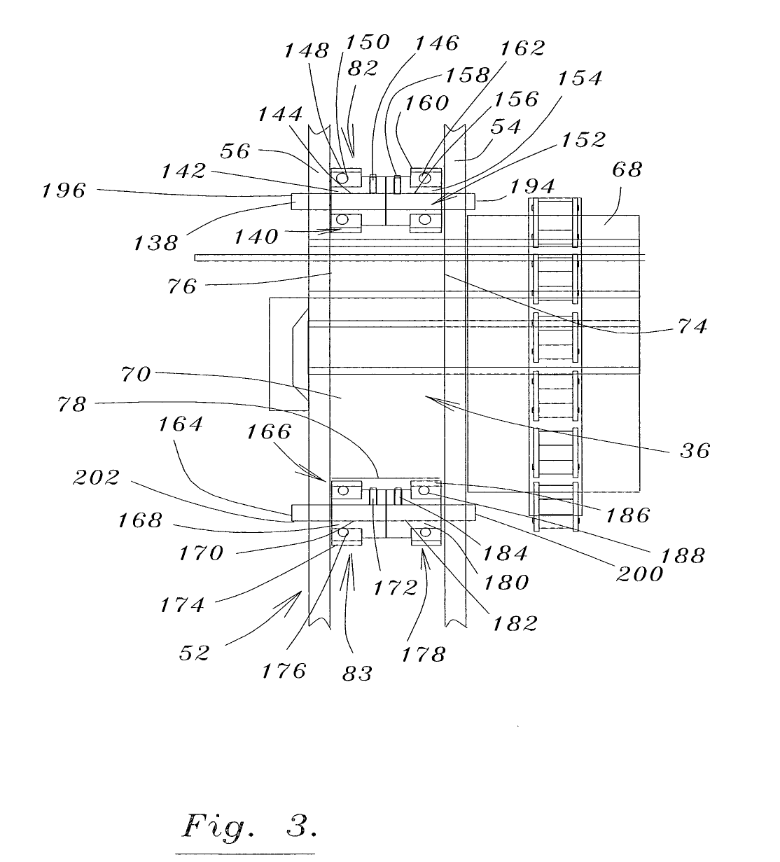

FIG. 3 is an enlarged view of the rotor 36 shown in FIG. 1. As shown in FIG. 3, the second portion 70 of the rotor 36 is secured to the first portion 68 of the rotor 36. The second portion 70 is disposed between the first plate 54 and the second plate 56 of the sub-frame 52 such that the first plate 54 and the second plate 56 rotatably support the second portion 70.

Additionally, the second portion 70 of the rotor 36 has a first extremity 74 and a second extremity 76. Also, the second portion 70 defines an outer surface 78 of cylindrical configuration.

Furthermore, the cylindrical outer surface 78 of the second portion 70 extends from the first extremity 74 of the second portion 70 to the second extremity 76 thereof.

As shown in FIGS. 2 and 3, a plurality of bearings generally designated 80, 81, 82 and 83 are supported by the first plate 54 and the second plate 56 of the sub-frame 52. The bearings 80-83 are disposed between the plates 54 and 56 and are spaced circumferentially around the outer surface 78 of the second portion 70 of the rotor 36 for bearingly supporting the second portion 70 of the rotor 36.

As shown in FIG. 2, the plurality of bearings 80-83 includes the first bearing 80 which has a first rod 84 which extends between the plates 54 and 56, the first rod 84 being secured to the plates 54 and 56.

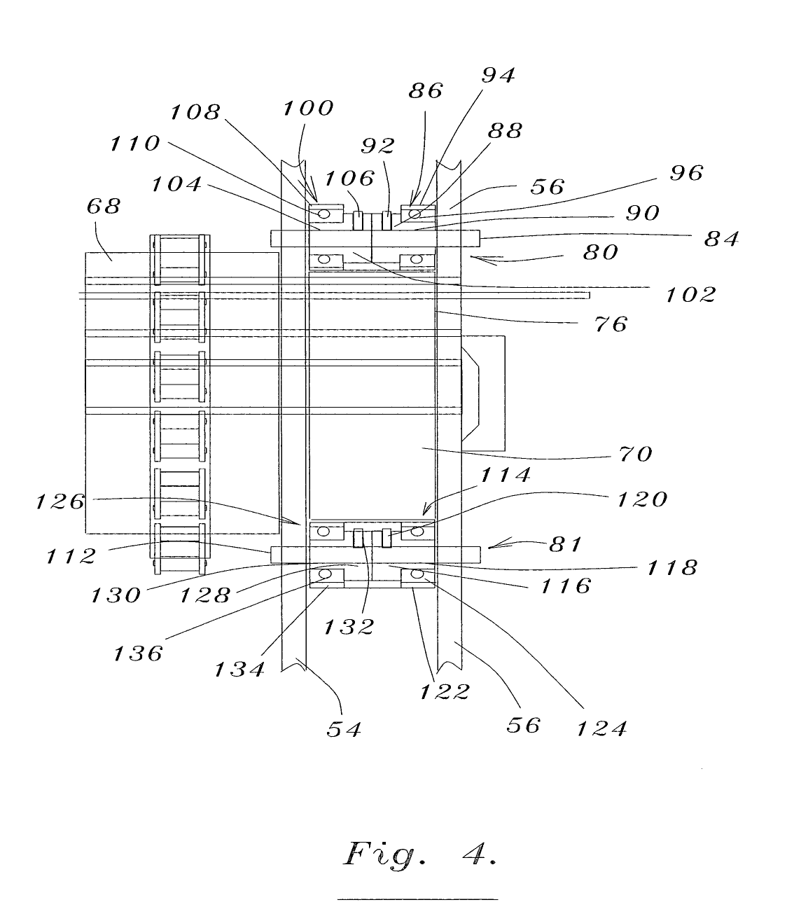

FIG. 4 is a sectional view taken on the line 4-4 of FIG. 2. As shown in FIG. 4, the first bearing 80 includes a first roller bearing generally designated 86. The first roller bearing 86 includes a first cylindrical axle 88 which defines a first axially extending passageway 90 for the reception therein of the first rod 84. A first locking device 92 is provided for locking the first cylindrical axle 88 onto the first rod 84 for preventing rotation and axial movement of the first cylindrical axle 88 relative to the first rod 84. Additionally, a first sleeve 94 is disposed coaxially relative to the first cylindrical axle 88 and a first bearing race 96 is disposed between the first sleeve 94 and the first cylindrical axle 88.

The first bearing 80 also includes a second roller bearing generally designated 100. The second roller bearing 100 includes a second cylindrical axle 102 which defines a second axially extending passageway 104 for the reception therein of the first rod 84. A second locking device 106 is provided for locking the second cylindrical axle 102 onto the first rod 84 for preventing rotation and axial movement of the second cylindrical axle 102 relative to the first rod 84. The second locking device 106 is disposed adjacent to the first locking device 92. A second sleeve 108 is disposed coaxially relative to the second cylindrical axle 102. Also, a second bearing race 110 is disposed between the second sleeve 108 and the second cylindrical axle 102.

Furthermore, the second bearing 81 includes a second rod 112 which extends between the plates 54 and 56, the second rod 112 being secured to the plates 54 and 56. A third roller bearing generally designated 114 includes a third cylindrical axle 116 which defines a third axially extending passageway 118 for the reception therein of the second rod 112. Also, a third locking device 120 is provided for locking the third cylindrical axle 116 onto the second rod 112 for preventing rotation and axial movement of the third cylindrical axle 116 relative to the second rod 112. A third sleeve 122 is disposed coaxially relative to the third cylindrical axle 116 and a third bearing race 124 is disposed between the third sleeve 122 and the third cylindrical axle 116.

Additionally, a fourth roller bearing generally designated 126 includes a fourth cylindrical axle 128 which defines a fourth axially extending passageway 130 for the reception therein of the second rod 112. A fourth locking device 132 is provided for locking the fourth cylindrical axle 128 onto the second rod 112 for preventing rotation and axial movement of the fourth cylindrical axle 128 relative to the second rod 112. The fourth locking device 132 is disposed adjacent to the third locking device 120. A fourth sleeve 134 is disposed coaxially relative to the fourth cylindrical axle 128. Also, a fourth bearing race 136 is disposed between the fourth sleeve 134 and the fourth cylindrical axle 128.

As shown in FIG. 3, the plurality of bearings 80-83 includes the third bearing 82 which has a third rod 138 extending between the plates 54 and 56, the third rod 138 being secured to the plates 54 and 56. A fifth roller bearing 140 includes a fifth cylindrical axle 142 which defines a fifth axially extending passageway 144 for the reception therein of the third rod 138. A fifth locking device 146 is provided for locking the fifth cylindrical axle 142 onto the third rod 138 for preventing rotation and axial movement of the fifth cylindrical axle 142 relative to the third rod 138. A fifth sleeve 148 is disposed coaxially relative to the fifth cylindrical axle 142 and a fifth bearing race 150 is disposed between the fifth sleeve 148 and the fifth cylindrical axle 142.

Also, a sixth roller bearing generally designated 152 includes a sixth cylindrical axle 154 which defines a sixth axially extending passageway 156 for the reception therein of the third rod 138. A sixth locking device 158 is provided for locking the sixth cylindrical axle 154 onto the third rod 138 for preventing rotation and axial movement of the sixth cylindrical axle 154 relative to the third rod 138. The sixth locking device 158 is disposed adjacent to the fifth locking device 146. A sixth sleeve 160 is disposed coaxially relative to the sixth cylindrical axle 154. Also, a sixth bearing race 162 is disposed between the sixth sleeve 160 and the sixth cylindrical axle 154.

The fourth bearing 83 includes a fourth rod 164 which extends between the plates 54 and 56, the fourth rod 164 being secured to the plates 54 and 56. A seventh roller bearing generally designated 166 includes a seventh cylindrical axle 168 which defines a seventh axially extending passageway 170 for the reception therein of the fourth rod 164. A seventh locking device 172 is provided for locking the seventh cylindrical axle 168 onto the fourth rod 164 for preventing rotation and axial movement of the seventh cylindrical axle 168 relative to the fourth rod 164. A seventh sleeve 174 is disposed coaxially relative to the seventh cylindrical axle 168. Also, a seventh bearing race 176 is disposed between the seventh sleeve 174 and the seventh cylindrical axle 168.

Additionally, an eighth roller bearing generally designated 178 includes an eighth cylindrical axle 180 which defines an eighth axially extending passageway 182 for the reception therein of the fourth rod 164. An eighth locking device 184 is provided for locking the eighth cylindrical axle 180 onto the fourth rod 164 for preventing rotation and axial movement of the eighth cylindrical axle 180 relative to the fourth rod 164. The eighth locking device 184 is disposed adjacent to the seventh locking device 172. An eighth sleeve 186 is disposed coaxially relative to the eighth cylindrical axle 180. Also, an eighth bearing race 188 is disposed between the eighth sleeve 186 and the eighth cylindrical axle 180.

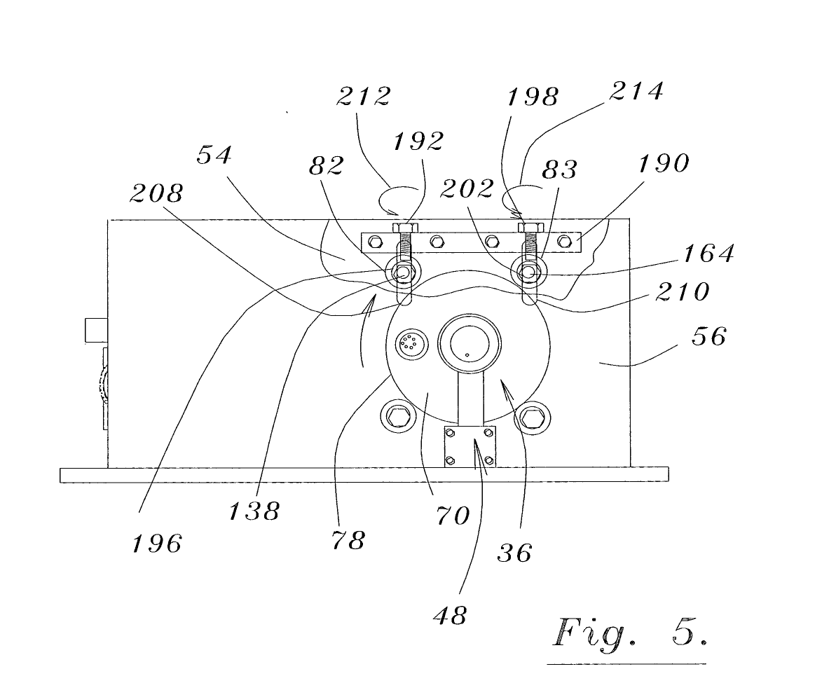

FIG. 5 is a similar view to that shown in FIG. 2 but is shown partly in section. As shown in FIG. 5, an anchor 190 is disposed between the plates 54 and 56 and is located adjacent to the third and fourth bearings 82 and 83. The anchor 190 is secured to at least one of the plates 54 and 56.

A first adjustment device 192 threadably cooperates with the anchor 190 and the first adjustment device 192 selectively urges the third rod 138 relative to the cylindrical outer surface 78 of the second portion 70 of the rotor 36.

As shown in FIG. 3, the third rod 138 has a first and a second end 194 and 196 respectively.

As shown in FIG. 5, a second adjustment device 198 threadably cooperates with the anchor 190 and the second adjustment device 198 selectively urges the fourth rod 164 relative to the cylindrical outer surface 78 of the second portion 70 of the rotor 36.

As shown in FIG. 3, the fourth rod 164 has a first and a second extremity 200 and 202 respectively.

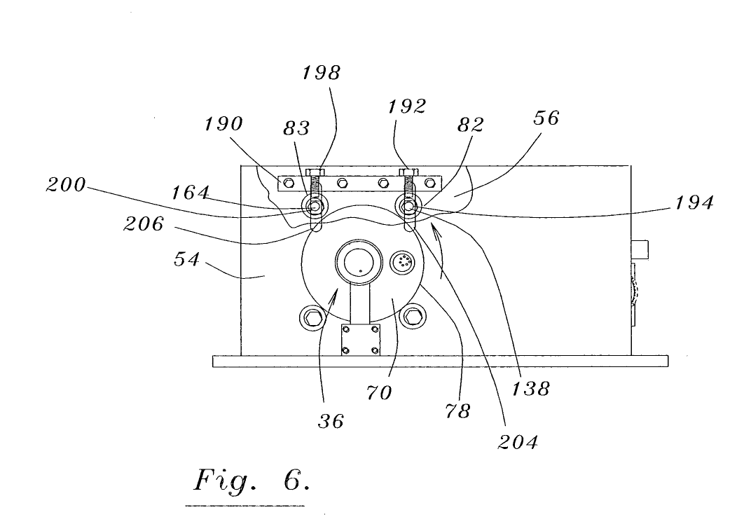

FIG. 6 is a view taken on the line 6-6 of FIG. 1. As shown in FIG. 6, the first plate 54 defines a first slot 204 for the adjustable reception therein of the first end 194 of the third rod 138.

Also, the first plate 54 defines a second slot 206 for the adjustable reception therein of the first extremity 200 of the fourth rod 164.

As shown in FIG. 5, the second plate 56 defines a third slot 208 for the adjustable reception therein of the second end 196 of the third rod 138.

Furthermore, the second plate 56 defines a fourth slot 210 for the adjustable reception therein of the second extremity 202 of the fourth rod 164. The arrangement is such that when the first and second adjustment devices 192 and 198 respectively are rotated relative to the anchor 190 as indicated by the arrows 212 and 214 respectively, a disposition of the fifth, sixth, seventh and eighth sleeves 148, 160, 174 and 186 respectively is adjusted relative to the cylindrical outer surface 78 of the second portion 70 of the rotor 36 so that a smooth rotation of the rotor 36 is attained.

As shown in FIG. 2, the shear 48 includes a blade 216 having a first and a second termination 218 and 220 respectively and a first and a second edge 222 and 224 respectively. The first edge 222 of the blade 216 defines a first shearing surface 226 and the second edge 224 of the blade 216 defines a second shearing surface 228.

An anchoring plate 230 cooperates with the first termination 218 of the blade 48 and a plurality of fasteners 232, 233, 234 and 235 are provided for securing the anchoring plate 230 to the second plate 56 of the sub-frame 52.

A threaded fastening device 236 extends through the anchoring plate 230 and cooperates with the blade 216 adjacent to the first termination 218 of the blade 216 for securing the blade 216 in the rotational path of the outlet 46 of the bore 42.

Also, a collar 238 threadably cooperates with the channel 40 of the rotor 36 for locating the second termination 220 of the blade 216 so that the blade 216 shears through the recyclable length L of the wound strands 18-20 when the rotor 36 rotates relative to the blade 216.

In operation of the apparatus 10 according to the present invention, an operator loosens the wound strands 18-20 from the core strand 16 by means of a channel lock tool or the like. The operator then rewinds the wound strands 18-20 about each other. The operator then threads the core strand 16 through the channel 40 of the rotor 36. Next, the operator threads the rewound wound strands 18-20 through the bore 42 of the rotor 36. The operator then switches the motor 32 to the forward mode so that the rotor rotates in a forward direction as indicated by the arrow 240. Accordingly, when the operator pulls the core strand 16 at a steady pace, the wound strands 18-20 will emerge from the outlet 46 of the bore 42. The arrangement is such that as the wound strands rotate about the axis of rotation 38 the recyclable lengths L will be urged against the first shearing surface 226 of the stationary blade 216 so that such lengths L are sheared and fall into a collecting container (not shown) for recycling thereof. The length L of the recyclable material 12 will depend on the steady pace at which the operator pulls the core strand 16 through the channel 40. The length L will also depend on the rotational speed of the rotor 36. The steel core strand 16 being pulled through the channel 40 may be coiled into a drum shaped container (not shown) for recycling thereof.

Although the operation includes the step of having the operator manually loosening the wound strands 18-20 from the core strand 16 by use of the channel lock tool, those skilled in the art will appreciate that this initial step and the step of threading the core strand 16 through the channel 40 and threading the wound strands 18-20 through the bore 42 could be accomplished by automated means. Also, the pulling of the core strand 16 through the channel 40 could be accomplished by an automated mechanism. Furthermore, the coiling of the core strand 16 could be controlled by an automatic coiling mechanism.

The aforementioned operations are applicable to recycling a cable from which the outer sheathing has been removed. The removal of such sheathing is accomplished by means of Applicant's apparatus disclosed in U.S. Pat. No. 6,694,853 to Adams.

Although the aforementioned electric cable has been described as having a core strand 16 with three wound strands 18-20 wound about the core strand 16, those skilled in the art will appreciate that there are many different types of electric cable 14 some of which have multiple core strands and several outer wound strands such as 12 or 18 outer wound strands.

Additionally, some electric cables include an inner cable of the aforementioned type but such cables also include a further plurality of outer wound strands which are wound in an opposite rotational direction relative to the plurality of inner wound strands. In this case, the operator loosens the outer plurality of wound strands. Such plurality of outer wound strands are then guided through the bore 42 and the core strand 16 together with the plurality of inner wound strands are pulled through the channel 40 so that the plurality of outer wound strands are sheared into recyclable lengths L. Because the plurality of outer wound strands are wound in the opposite rotational direction relative to the plurality of inner wound strands, it is necessary for the motor 32 to be switched to the reverse rotational direction R for shearing the outer wound strands into the required lengths. With the motor 32 switched for reverse rotation, the second shearing surface 228 shears the plurality of outer wound strands. Subsequently, after loosening the inner wound strands from the core strand 16, the core strand 16 is threaded through the channel 40 and the inner wound strands 18-20 are threaded through the bore 42. The operator then pulls the core strand 16 while the motor 32 is switched to the forward disposition thereof for shearing the inner wound strands into the required lengths for subsequent recycling.

The present invention provides a unique and versatile apparatus for efficiently shearing electric cables for recycling thereof.

What is claimed is:

1. An apparatus for retrieving recyclable metal from an electrical cable having a core strand and wound strands wound about the core strand, said apparatus comprising:
a frame having a first and a second end and a first and a second side;
a motor mounted on said frame;
a drive drivably connected to said motor;
a rotor rotatably supported by said frame, said rotor being drivingly connected to said drive such that when said motor is energized, said motor rotates said rotor about an axis of rotation of said rotor, said rotor defining a channel for the passage therethrough of the core strand, said channel extending coaxially about said axis of rotation of said rotor, said rotor also defining a bore for the passage therethrough of the wound strands, said bore being disposed parallel to and spaced relative to said axis of rotation, said bore having an inlet and an outlet; and
a shear secured to said frame adjacent to said rotor such that when said rotor is rotating and the wound strands are urged through said bore, said outlet of said bore interacts with said shear for shearing a recyclable length of the wound strands for recycling thereof.

2. An apparatus for retrieving recyclable metal as set forth in claim 1 wherein
said frame includes:
a main frame having said first and a second end and said first and a second side;
a sub-frame extending from said main frame, said sub-frame including:
a first plate extending between said first and second ends of said main frame;
a second plate disposed spaced and parallel to said first plate such that said first and second plate rotatably support said rotor.

3. An apparatus for retrieving recyclable metal as set forth in claim 2 wherein
said main frame is of rectangular configuration.

4. An apparatus for retrieving recyclable metal as set forth in claim 1 wherein
said motor is an electric motor.

5. An apparatus for retrieving recyclable metal as set forth in claim 4 further including:
a switch for selectively permitting forward and reverse rotation of said motor when energized.

6. An apparatus for retrieving recyclable metal as set forth in claim 4 further including:
a reduction gearbox drivingly connected to said motor, said gearbox having an input and an output, said input being driven by said motor, said output being drivingly connected to said drive.

7. An apparatus for retrieving recyclable metal as set forth in claim 6 wherein
said output of said gearbox includes:
a drive sprocket.

8. An apparatus for retrieving recyclable metal as set forth in claim 1 wherein
said drive is a chain.

9. An apparatus for retrieving recyclable metal as set forth in claim 2 wherein
said rotor includes:
a first and a second portion;
a driven sprocket secured to said first portion of said rotor, said driven sprocket cooperating with said drive such that said driven sprocket is driven by said drive so that said driven sprocket and said first portion of said rotor are rotated about said axis of rotation.

10. An apparatus for retrieving recyclable metal as set forth in claim 9 wherein
said second portion of said rotor is secured to said first portion of said rotor, said second portion being disposed between said first and second plates of said sub-frame such that said first and second plates rotatably support said second portion.

11. An apparatus for retrieving recyclable metal as set forth in claim 10 wherein
said second portion of said rotor has a first and a second extremity, said second portion defining an outer surface of cylindrical configuration.

12. An apparatus for retrieving recyclable metal as set forth in claim 11 wherein
said cylindrical outer surface of said second portion extends from said first extremity of said second portion to said second extremity thereof.

13. An apparatus for retrieving recyclable metal as set forth in claim 12 further including:
a plurality of bearings supported by said first and second plates of said sub-frame, said bearings being disposed between said plates and spaced circumferentially around said outer surface of said second portion of said rotor for bearingly supporting said second portion of said rotor.

14. An apparatus for retrieving recyclable metal as set forth in claim 13 wherein
said plurality of bearings includes:
a first bearing which includes:
a first rod extending between said plates, said first rod being secured to said plates;
a first roller bearing;
said first roller bearing including:
a first cylindrical axle defining a first axially extending passageway for the reception therein of said first rod;
a first locking device for locking said first cylindrical axle onto said first rod for preventing rotation and axial movement of said first cylindrical axle relative to said first rod;
a first sleeve disposed coaxially relative to said first cylindrical axle;
a first bearing race disposed between said first sleeve and said first cylindrical axle;
a second roller bearing;
said second roller bearing including:
a second cylindrical axle defining a second axially extending passageway for the reception therein of said first rod;
a second locking device for locking said second cylindrical axle onto said first rod for preventing rotation and axial movement of said second cylindrical axle relative to said first rod, said second locking device being disposed adjacent to said first locking device;
a second sleeve disposed coaxially relative to said second cylindrical axle;
a second bearing race disposed between said second sleeve and said second cylindrical axle;
a second bearing which includes:
a second rod extending between said plates, said second rod being secured to said plates;
a third roller bearing;
said third roller bearing including:
a third cylindrical axle defining a third axially extending passageway for the reception therein of said second rod;
a third locking device for locking said third cylindrical axle onto said second rod for preventing rotation and axial movement of said third cylindrical axle relative to said second rod;
a third sleeve disposed coaxially relative to said third cylindrical axle;
a third bearing race disposed between said third sleeve and said third cylindrical axle;
a fourth roller bearing;
said fourth roller bearing including:
a fourth cylindrical axle defining a fourth axially extending passageway for the reception therein of said second rod;
a fourth locking device for locking said fourth cylindrical axle onto said second rod for preventing rotation and axial movement of said fourth cylindrical axle relative to said second rod, said forth locking device being disposed adjacent to said third locking device;
a fourth sleeve disposed coaxially relative to said fourth cylindrical axle;
a fourth bearing race disposed between said fourth sleeve and said fourth cylindrical axle.

15. An apparatus for retrieving recyclable metal as set forth in claim 14 wherein
said plurality of bearings includes:
a fifth bearing which includes:
a third rod extending between said plates, said third rod being secured to said plates;
a fifth roller bearing;
said fifth roller bearing including:
a fifth cylindrical axle defining a fifth axially extending passageway for the reception therein of said third rod;
a fifth locking device for locking said fifth cylindrical axle onto said third rod for preventing rotation and axial movement of said fifth cylindrical axle relative to said third rod;
a fifth sleeve disposed coaxially relative to said fifth cylindrical axle;
a fifth bearing race disposed between said fifth sleeve and said fifth cylindrical axle;
a sixth roller bearing;
said sixth roller bearing including:
a sixth cylindrical axle defining a sixth axially extending passageway for the reception therein of said third rod;
a sixth locking device for locking said sixth cylindrical axle onto said third rod for preventing rotation and axial movement of said sixth cylindrical axle relative to said third rod, said sixth locking device being disposed adjacent to said fifth locking device;
a sixth sleeve disposed coaxially relative to said sixth cylindrical axle;
a sixth bearing race disposed between said sixth sleeve and said sixth cylindrical axle;
a fourth bearing which includes:
a fourth rod extending between said plates, said fourth rod being secured to said plates;
a seventh roller bearing;
said seventh roller bearing including:
a seventh cylindrical axle defining a seventh axially extending passageway for the reception therein of said fourth rod;
a seventh locking device for locking said seventh cylindrical axle onto said fourth rod for preventing rotation and axial movement of said seventh cylindrical axle relative to said fourth rod;
a seventh sleeve disposed coaxially relative to said seventh cylindrical axle;
a seventh bearing race disposed between said seventh sleeve and said seventh cylindrical axle;
an eighth roller bearing;
said eighth roller bearing including:
an eighth cylindrical axle defining an eighth axially extending passageway for the reception therein of said fourth rod;
an eighth locking device for locking said eighth cylindrical axle onto said fourth rod for preventing rotation and axial movement of said eighth cylindrical axle relative to said fourth rod, said eighth locking device being disposed adjacent to said seventh locking device;
an eighth sleeve disposed coaxially relative to said eighth cylindrical axle;
an eighth bearing race disposed between said eighth sleeve and said eighth cylindrical axle.

16. An apparatus for retrieving recyclable metal as set forth in claim 15 further including:
an anchor disposed between said plates and disposed adjacent to said third and fourth bearings, said anchor being secured to at least one of said plates;
a first adjustment device threadably cooperating with said anchor, said first adjustment device selectively urging said third rod relative to said cylindrical outer surface of said second portion of said rotor, said third rod having a first and a second end;
a second adjustment device threadably cooperating with said anchor, said second adjustment device selectively urging said fourth rod relative to said cylindrical outer surface of said second portion of said rotor, said fourth rod having a first and a second extremity;
said first plate defining a first slot for the adjustable reception therein of said first end of said third rod;
said first plate defining a second slot for the adjustable reception therein of said first extremity of said fourth rod;
said second plate defining a third slot for the adjustable reception therein of said second end of said third rod;
said second plate defining a fourth slot for the adjustable reception therein of said second extremity of said fourth rod, such that when said first and second adjustment devices are rotated relative to said anchor, a disposition of said fifth, sixth, seventh and eighth sleeves relative to said cylindrical outer surface of said second portion of said rotor is adjusted so that a smooth rotation of said rotor is attained.

17. An apparatus for retrieving recyclable metal as set forth in claim 1 wherein
said shear includes:
a blade having a first and a second termination and a first and a second edge, said first edge of said blade defining a first shearing surface, said second edge of said blade defining a second shearing surface;
an anchoring plate cooperating with said first termination of said blade;
a plurality of fasteners for securing said anchoring plate to said second plate of said sub-frame;
a threaded fastening device extending through said anchoring plate and cooperating with said blade adjacent to said first termination of said blade for securing said blade adjacent to said outlet of said bore;
a collar threadably cooperating with said channel of said rotor for locating said second termination of said blade so that said blade shears through said recyclable length of the wound strands when said rotor rotates relative to said blade.

18. An apparatus for retrieving recyclable metal from an electrical cable having a core strand and wound strands wound about the core strand, said apparatus comprising:
a frame having a first and a second end and a first and a second side;
a motor mounted on said frame;
a drive drivably connected to said motor;
a rotor rotatably supported by said frame, said rotor being drivingly connected to said drive such that when said motor is energized, said motor rotates said rotor about an axis of rotation of said rotor, said rotor defining a channel for the passage therethrough of the core strand, said channel extending coaxially about said axis of rotation of said rotor, said rotor also defining a bore for the passage therethrough of the wound strands, said bore being disposed parallel to and spaced relative to said axis of rotation, said bore having an inlet and an outlet;
a shear secured to said frame adjacent to said rotor such that when said rotor is rotating and the wound strands are urged through said bore, said outlet of said bore interacts with said shear for shearing a recyclable length of the wound strands for recycling thereof; and
said shear including:
a blade having a first and a second termination and a first and a second edge, said first edge of said blade defining a first shearing surface, said second edge of said blade defining a second shearing surface.

19. An apparatus for retrieving recyclable metal from an electrical cable having a core strand and wound strands wound about the core strand, said apparatus comprising:
a frame having a first and a second end and a first and a second side;
a motor mounted on said frame;
a drive drivably connected to said motor;
a rotor rotatably supported by said frame, said rotor being drivingly connected to said drive such that when said motor is energized, said motor rotates said rotor about an axis of rotation of said rotor, said rotor defining a channel for the passage therethrough of the core strand, said channel extending coaxially about said axis of rotation of said rotor, said rotor also defining a bore for the passage therethrough of the wound strands, said bore being disposed parallel to and spaced relative to said axis of rotation, said bore having an inlet and an outlet;
a shear secured to said frame adjacent to said rotor such that when said rotor is rotating and the wound strands are urged through said bore, said outlet of said bore interacts with said shear for shearing a recyclable length of the wound strands for recycling thereof;
said frame including:
a main frame having said first and a second end and said first and a second side;
a sub-frame extending from said main frame, said sub-frame including:
a first plate extending between said first and second ends of said main frame;
a second plate disposed spaced and parallel to said first plate such that said first and second plate rotatably support said rotor;
said main frame being of rectangular configuration;
said motor being an electric motor;
a switch for selectively permitting forward and reverse rotation of said motor when energized;
a reduction gearbox drivingly connected to said motor, said gearbox having an input and an output, said input being driven by said motor, said output being drivingly connected to said drive;
said output of said gearbox including:
a drive sprocket;
said drive being a chain;
said rotor including:
a first and a second portion;
a driven sprocket secured to said first portion of said rotor, said driven sprocket cooperating with said drive such that said driven sprocket is driven by said drive so that said driven sprocket and said first portion of said rotor are rotated about said axis of rotation;
said second portion of said rotor being secured to said first portion of said rotor, said second portion being disposed between said first and second plates of said sub-frame such that said first and second plates rotatably support said second portion;
said second portion of said rotor having a first and a second extremity, said second portion defining an outer surface of cylindrical configuration;
said cylindrical outer surface of said second portion extending from said first extremity of said second portion to said second extremity thereof;
a plurality of bearings supported by said first and second plates of said sub-frame, said bearings being disposed between said plates and spaced circumferentially around said outer surface of said second portion of said rotor for bearingly supporting said second portion of said rotor;
said shear including:
a blade having a first and a second termination and a first and a second edge, said first edge of said blade defining a first shearing surface, said second edge of said blade defining a second shearing surface;
an anchoring plate cooperating with said first termination of said blade;
a plurality of fasteners for securing said anchoring plate to said second plate of said sub-frame;
a threaded fastening device extending through said anchoring plate and cooperating with said blade adjacent to said first termination of said blade for securing said blade adjacent to said outlet of said bore; and
a collar threadably cooperating with said channel of said rotor for locating said second termination of said blade so that said blade shears through said recyclable length of the wound strands when said rotor rotates relative to said blade.
